(19) United States
(12) Patent Application Publication
(10) Pub. No.: US 2005/0115053 A1
(43) Pub. Date: Jun. 2, 2005

(54) Method of inserting a joint into metal, pvc or similar joinery sections

(75) Inventor: Juan Jose Vila Fernandez, Valencia (ES)

Correspondence Address: Richard M Goldberg, Suite 419, 25 East Salem Street, Hackensack, NJ, 07601, US

(73) Assignee: Vicente Villa, S.L., Valencia (ES)

(21) Appl. No.: 10/508,425

(22) PCT Filed: May 27, 2002
(86) PCT No.: PCT/ES02/00252

(51) Int. Cl. B23P 11/02

(52) U.S. Cl. 29/564.7; 29/451

(57) ABSTRACT

A method of inserting a joint into joinery sections includes the following operations: positioning the joint in a joint supply device, disposing the section in a joint receiving position, introducing the section parameters, cutting the end of the joint at a pre-defined angle, moving the joint towards the section, cutting the second end of the joint and subsequently moving the joint until it is inserted fully in the section. A machine for inserting a joint in joinery sections, includes a bench, whereon a section is placed; a supply device including a groove through which the joint is inserted, the joint being moved by a push device; a device for metering the passage of the joint, including rollers; an assembly of shear blades, each blade having a pre-determined cutting direction; and a device for supporting the receiving section and a section release device.

The object of this invention is a method for inserting a gasket in metal, PVC and similar carpentry profiles, and more specifically a method based on a mechanism allowing the insertion of a rubber gasket or weather strip in carpentry profiles and later cutting or trimming of said gasket.

The closest state of the art is disclosed in ES 2154528, this invention being based on a machine for automatically and continuously inserting a gasket or weather strip in profiles, forming part of a machine bed with a work surface, where the profiles are set out. The machine is activated electronically by insertion of the profile, thanks to a set of photoelectric cells aligned along the bed, which detect the presence of the profile and activate the mechanisms or stop these when the profile has to be removed. A pulling slide is manually activated to insert the weather strip in the gasket holder, moving this along the bed right to the end, where there is an electric brake, which makes it stop and simultaneously activates a cutting device located at the head of the machine, which cuts the gasket or weather strip at a point close to that of the end of the profile where the insertion started.

The gasket is elastic, meaning that when it is pulled along by a pulling slide and braked by an electric brake, after cutting, the length of the gasket gives margins of error, leading to errors when the profiles are assembled.

It is desirable to ensure an accurate cut so as not to have to check the profiles later with the rubber gasket inserted and have to cut off any possible surplus off this, leading to a reduction in costs through avoiding labour in trimming off the end of the gasket, at the same time as improving the quality of the final product.

This invention consists in a method for inserting the gasket in metal, PVC or similar carpentry profiles, which includes a means of predetermining the profile length, means for repairing the end of the rubber gasket or weather strip, means for inserting said gasket in the profile, means for securing the profile and means for ejecting this.

This invention also refers to a machine for inserting gaskets in metal, PVC or similar carpentry profiles, consisting of a machine bed which can be as long as required, depending on the length of the profile, which is set on said bed. The machine is supplied with rolls of gaskets normally placed under the surface of the bed. The machine has a supply or feed device, with a slot through which the gasket is inserted, this gasket being moved by the action of a pushing device, which consists of a drive means. It also has a counting device for the gasket as it goes by consisting of rollers, and a set of cutting blades, each with a pre-set cutting angle. Lastly, said machine also consists of a device for holding the receiving profile and a device for ejecting this.

In order to make the following explanation clearer, six sheets of drawings are adjoined to this description representing the essence of the invention, in which:

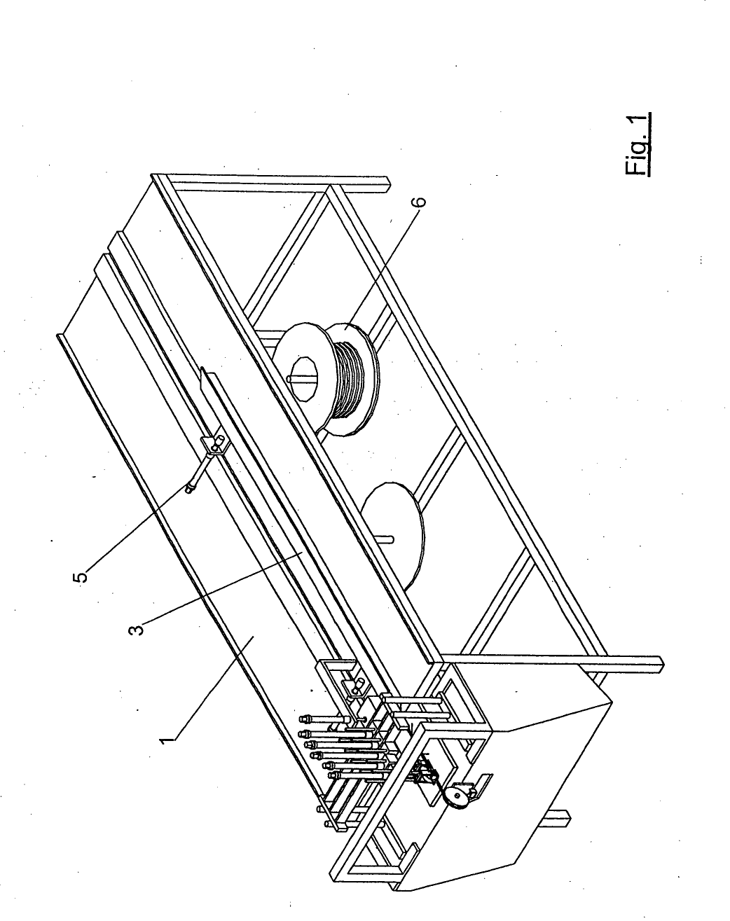

FIG. 1 shows a general perspective view of the assembly constituting the object of this invention;

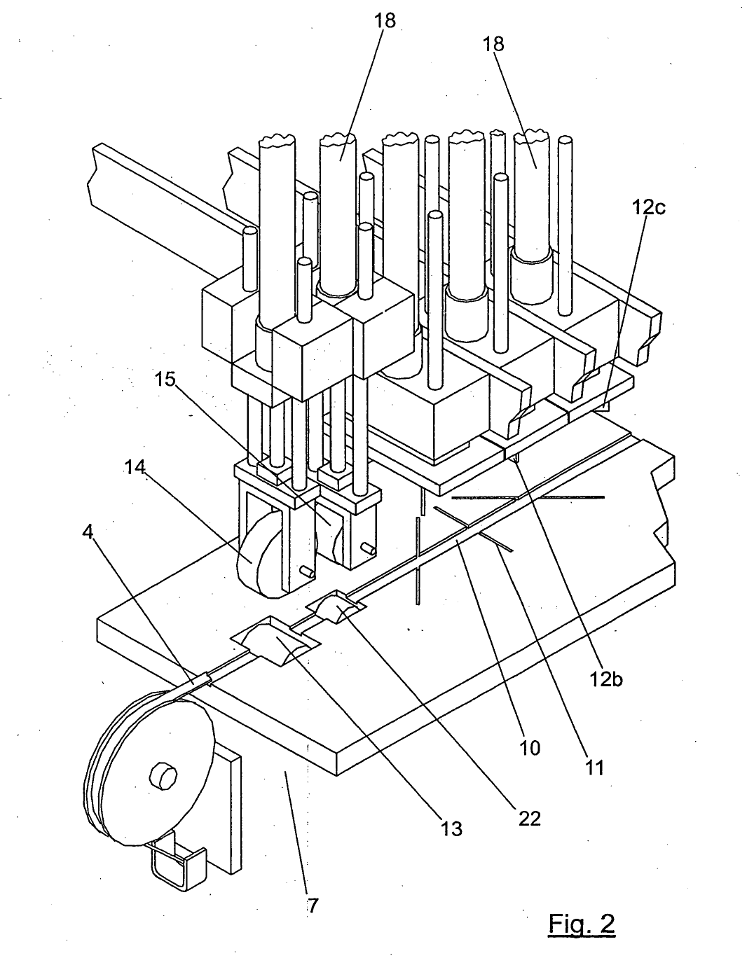

FIG. 2 shows a perspective view of the motor device, the counter device and the cutting device;

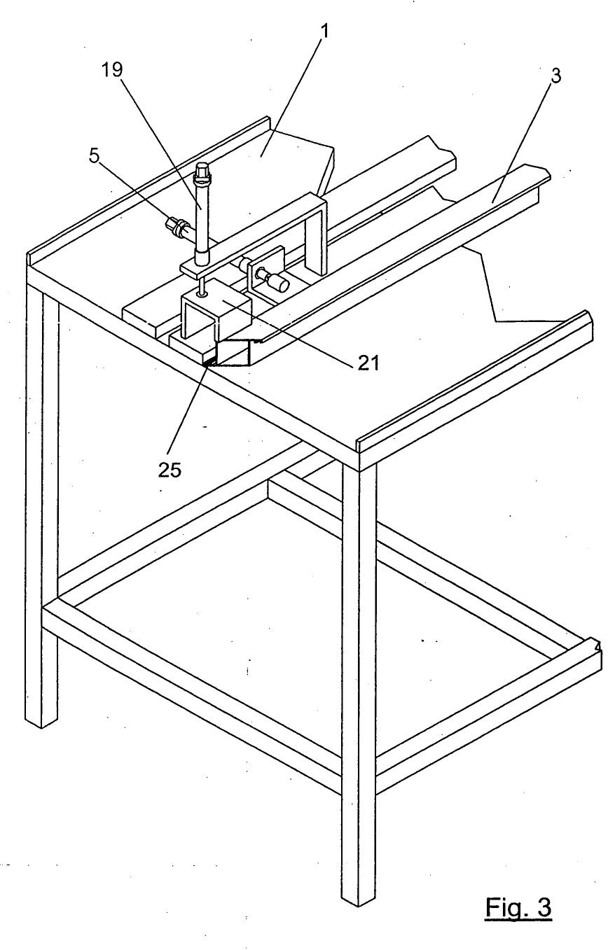

FIG. 3 shows a perspective view of the assembly consisting of the profile, the securing means and the means for ejecting this;

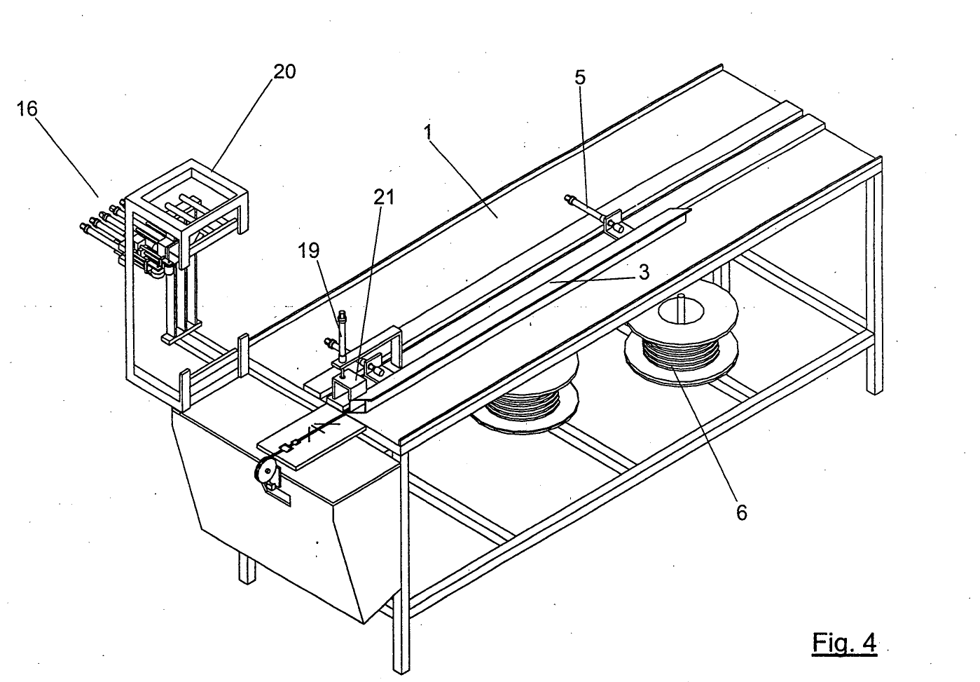

FIG. 4 shows a perspective view of the assembly of motor, counter and cutting devices, articulated on a shaft located at one of its ends;

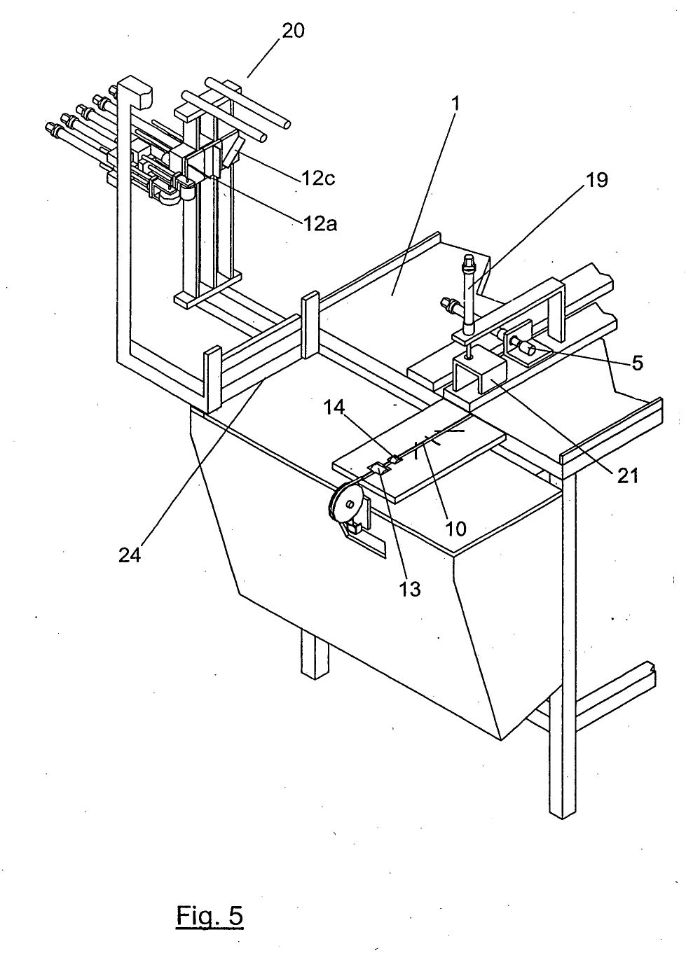

FIG. 5 shows a perspective view of the previous figure;

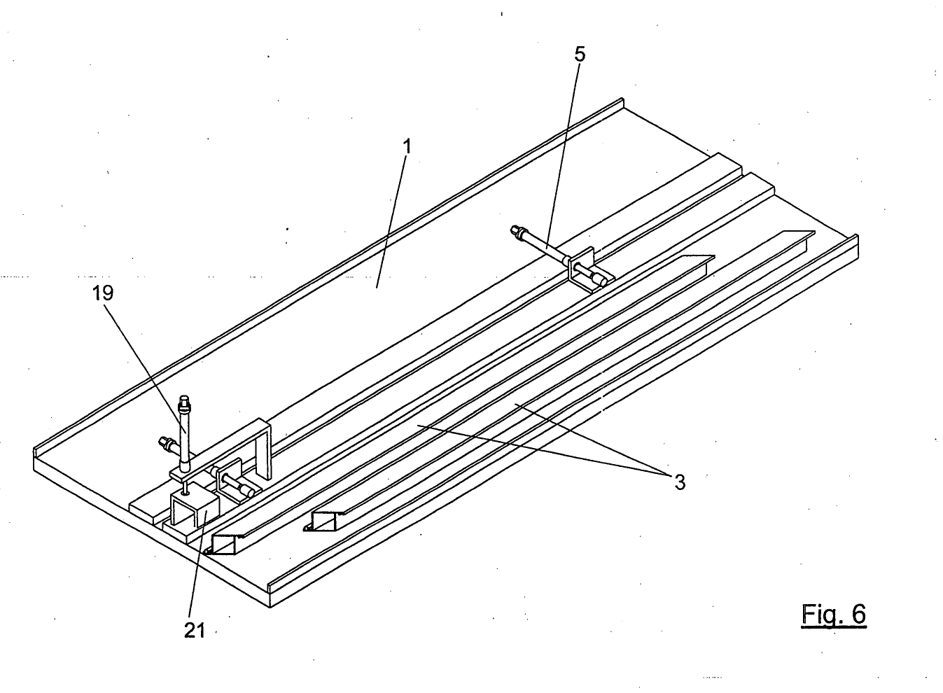

FIG. 6 shows a perspective view of the surface of the bed including an ejection device, on which there are several profiles with the rubber gasket inserted.

In these figures we are shown a preferential embodiment, in which 1 represents a machine bed longitudinally designed to take any size of profile 3, in which the rubber gasket 4 is inserted, and sufficiently wide to house a set of profiles after being pushed by an ejection device 5 consisting in pneumatic pushing devices for the profile 3, after inserting and cutting the gasket 4. This gasket comes from rolls of gasket 6, which are set under the bed 1.

7 shows a supply device fitted with a slot 10 in which the gasket 4 is inserted, and along which it moves thanks to a gasket pushing device 13, 14, consisting of a drive means. This pushing device consists of at least one drive roller 13, which cooperates with a second drive roller 14, which presses against the first, meaning that the gasket 4 is trapped.

Measurement of gasket displacement is done by means of a counting device gauging the gasket as it passes by 15, 22, formed of at least one counter roller or encoder 22, which cooperates with a second pressure roller 15.

12a, 12b and 12c show a set of cutting blades, one for each of the pre-set cutting angles, normally at 45° from the longitudinal axis of the profile, transversal to this or at −45°. This set of cutting blades cooperates with slots 11 set opposite to that of the gasket 4.

21 represents a device for holding the profile, consisting in a clamp driven by pneumatic means 19.

16 is one of the parts of the motor, counter and cut device assembly, which is able to be raised by pneumatic means 18. This part 16 is set on a body able to be articulated 20, on a shaft 24, which is set on a plane parallel to the gasket feeding line.

The method for inserting a gasket in profiles includes the following stages:

First of all the gasket 4 is set on the gasket supply device 7, then the profile 3 is placed in a gasket reception position, in which a reception slot 25 is placed aligned with the supply device 7; then the parameters of the profile are entered, these parameters being the maximum length of the profile, and the angles which form the ends against the longer members; then the cut is made at the end of the gasket 4 in accordance with the angle of the corresponding end of the profile 3 and the gasket is moved towards the profile to cut the second end at the pre-set angle. Then the gasket is pushed until being fully inserted into the reception profile and lastly, after inserting the gasket 4 in profile 3, this is ejected by the ejection device 5, fitted on the bed 1, on a plane perpendicular to profile 3.

In alternative embodiments, both the motor device and the cutting device or pushing device can be driven by means other than pneumatic ones, such as manual or other systems.

For any due purposes it is hereby stated that the nature of the invention is not restricted to the exact details of this description, any modifications which do not affect the essence, what is expressed and relative to this patent not altering said nature.

This item is for industrial application in making metal, PVC or similar profiles, with a rubber gasket or weather strip inserted.

1. Method for inserting gaskets in metal, PVC and similar carpentry profiles, comprising the steps of:
setting a gasket in a gasket supply device;
placing a profile in a gasket reception position, in which a reception slot of the profile is aligned with the supply device;
introducing and storing profile parameters of the profile in a central processing unit, these parameters including a maximum profile length and angles that form ends against longer members of the profile;
cutting an end of the gasket to match angle of a corresponding end of the profile;
moving the gasket towards the profile along an insertion slot included in the gasket supply device by a distance equal to the length of the profile;
adding or subtracting the distance to the cutting blade corresponding to a pre-set angle at the other end of the profile;
cutting the other end of the profile with a pre-set angle;
pushing the gasket until the whole gasket is inserted in the reception profile.

2. Method according to claim 1, wherein the steps of cutting are performed in a zone prior to an insertion zone, in a profile feeding direction.

3. Method according to claim 1, wherein the steps of cutting are performed by different blades set at the pre-set angles that the profile may require at its ends.

4. Method according to claim 1, further comprising a multiple gasket feeder, allowing one or another feeding channel to be selected one of:
automatically and
manually.

5. Method according to claim 1, further comprising an encoder for measuring gasket displacement.

6. Method according to claim 1, further comprising a motor device linked to a drive roller so that the gasket is trapped and pushed in combination with a second roller set opposite said drive roller.

7. Method according to claim 3, further comprising a pneumatic arrangement for driving the blades.

8. Machine for insertion of gaskets in metal, PVC and similar carpentry profiles, said profiles being provided with an insertion slot for the gasket, comprising:
a bed for supporting a profile, in which at least one position for location of the profile in the insertion position is defined;
at least one gasket feeding device provided with a slot in which a gasket is inserted;
a pushing device for moving the gasket from a casket roll, with reversible movement, along the slot, the pushing device including a motor;
at least one device for counting a length of the gasket passing by;
at least one set of cutting blades, one for each of pre-set cutting angles, normally coinciding with each of angles of ends of the profile;
at least one securing device for the profile to be inserted;
a device for controlling forward or backward movement of the gaskets; and
a central processing unit for storing profile parameters, these parameters including maximum profile length and angles of the profile ends.

9. Machine according to claim 8, wherein the central processing unit which stores the profile parameters also receives the parameters of the profile in use.

10. Machine according to claim 8, wherein the pushing device is formed by at least one drive roller which cooperates with a second drive roller pressing against the at least one drive roller.

11. Machine according to claim 8, wherein the at least one counting device includes at least one counter roller which cooperates with a second pressure roller.

12. Machine according to claim 8, wherein the cutting blades cooperate with corresponding slots in the at least one gasket feeding device set opposite to the gasket.

13. Machine according to claim 8, further comprising an assembly for raising at least of:
the motor,
the at least one device for counting and the at least one set of cutting blades.

14. Machine according to claim 8, wherein at least one of the motor, the at least one device for counting and the at least one set of cutting blades is set on a body that can articulate on an axis substantially parallel to a supply line of the gasket and sufficiently far from said axis, allowing access for maintenance and insertion of the gasket in the slot.

15. Machine according to claim 8, wherein the at least one securing device includes a moveable clamp by and a pneumatic assembly for driving the moveable clamp.

16. Machine according to claim 8, further comprising at least one ejection device for pushing the profile after inserting and cutting the gasket, the pushing distance being sufficient to release the insertion position of a new profile.

17. Machine according to claim 16, wherein the bed is wide enough to house a set of profiles after the profiles are pushed by the ejection device.
